(19) United States
(12) Patent Application Publication
(10) Pub. No.: US 2013/0118862 A1
(43) Pub. Date: May 16, 2013

(54) Pivoting Conveyor System

(71) Applicant: All-Right Steel LLC, Cushing, OK (US)

(72) Inventor: Larry Lin Stewart, Stillwater, OK (US)

(73) Assignee: All-Right Steel LLC, Cushing, OK (US)

(21) Appl. No.: 13/677,706

(22) Filed: Nov. 15, 2012

Related U.S. Application Data
(60) Provisional application No. 61/559,795, filed on Nov. 15, 2011.

(51) Int. Cl. B65G 21/12

(52) U.S. Cl. CPC B65G 21/12
USPC 198/300; 198/587

(57) ABSTRACT

The embodiments of the Pivoting Conveyor System comprise a feed assembly, plurality of conveying assemblies, and a plurality of pivoting assemblies. These embodiments allow the entire embodiment to articulate in a wide variety of conformations and be placed in various orientations such that the feed assembly can be moved to adjust to the location of the mineral source, such as a rock formation, and transport the material from the quarrying location to the final storage location. In addition, the articulating motion of the embodiments allow for the end of the embodiments to be moved and adjusted as required to transport the material to the desired end location.

### CROSS-REFERENCE TO RELATED APPLICATIONS

This application claims priority of the U.S. Provisional Patent Application with Ser. No. 61/559,795 titled “Pivoting Conveyor System” filed on Nov. 15, 2011. The entire contents of U.S. Provisional Patent Application 61/559,795 is incorporated by reference herein.

### STATEMENT REGARDING FEDERALLY SPONSORED RESEARCH OR DEVELOPMENT

Not applicable

### FIELD OF THE EMBODIMENTS

The field of the embodiments is conveying machinery and devices, particularly, but not limited to, conveying heavy raw materials such as rocks, stones and other minerals in quarrying operations.

### BACKGROUND OF THE EMBODIMENTS

Conveying systems are commonly used in quarrying operations, as well as other operations that extract minerals and other resources, to move the raw materials from one location to another. It is common in quarrying applications to provide a means of transporting the extracted material from the quarry using a conveying means. As the quarrying progresses, the point at which the raw material is fed to the conveying system moves. For example, as rock is quarried, the rock face from which the rock is removed necessarily moves as the rock is removed. When the rock face is being readied with explosives, any material moving systems must be moved out of the way of any harmful effects of the blast including falling debris. Once the rock face is blasted and readied, the material moving system is returned into position for the purpose of conveying minerals from the vicinity of the rock face to the central processing facility. Therefore, the beginning point in the conveying system must be moved to track the location of the beginning rock face.

Commonly, the discharge point of the conveying system is at a fixed location. Typically, this fixed location is where further mineral processing takes place. Alternatively, the end point of the conveying system must move to accommodate changing storage and transportation conditions at the end of the conveying system. In some cases, it is necessary to have a conveying system that allows for the beginning segment, middle segment, or both beginning and end segments of the conveying system to move as needed.

### SUMMARY OF THE EMBODIMENTS

In summary, the embodiments of the Pivoting Conveyor System comprise a feed assembly, plurality of conveying assemblies, and a plurality of pivoting assemblies. These embodiments allow the entire embodiment to articulate in a wide variety of conformations and be placed in various orientations such that the feed assembly can be moved to adjust to the location of the mineral source, such as a rock formation, and transport the material from the quarrying location to the final processing location. In addition, the articulating motion of the embodiments allow for the end of the embodiments to be moved and adjusted as required to transport the material to the desired end location.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is a schematic of an embodiment of the Pivoting Conveyor System showing how the system can be oriented in different ways to accommodate production of minerals.

FIG. 2 is a perspective view of an embodiment of the articulating conveyor showing a track-mounted crusher/feeder unit and the first conveyor unit is supported by the crusher/feeder unit and the second section supported by a wheel base unit.

FIG. 3 is a perspective close-up view of the pivoting assembly of an embodiment of the Pivoting Conveying System wherein this pivoting assembly is supported by a wheeled unit. The deflector plates and pulley have been left off this drawing for clarity.

FIG. 4 shows a side view of a section of an embodiment of the Pivoting Conveying System. The deflector plates and pulley have been left off this drawing for clarity.

FIG. 5 is a detailed view of the chute in the pivoting assembly of an embodiment of the Pivoting Conveying System.

FIG. 6 is a front view showing the pivoting assembly including the chute of an embodiment of the Pivoting Conveying System.

FIG. 7 shows a sectional view of the pivoting assembly and the connection between the incoming conveyor and the outgoing conveyor in an embodiment of the Pivoting Conveying System.

FIG. 8 is a perspective view showing how material leaves one conveyor segment, empties into the chute, and discharges into a downstream conveying segment of an embodiment of the Pivoting Conveying System.

FIG. 9 is a perspective view of the pivoting assembly and the connection between the incoming conveyor and the outgoing conveyor in an embodiment of the Pivoting Conveying System.

FIG. 10A is a side view of an embodiment of the articulating conveyor showing the feed unit on track-mounted pivot units and the first conveying section self-supported and the second conveying section supported by a wheel base unit; FIG. 10B is a prospective view of an embodiment of the articulating conveyor showing the feed unit on track-mounted pivot units and the first conveying section self-supported and the second conveying section supported by a wheel base unit.

FIG. 11A is a side view of an embodiment showing how a plurality of conveying units with a track-mounted feed hopper connected with a unit supported by a wheel-mounted pivot units with an end conveyor assembly location means aligning the feed unit with the first conveying unit; FIG. 11B is a prospective view of an embodiment showing how a plurality of conveying units can be connected together with the unit supported by wheel-mounted pivot units with an end conveyor assembly location means aligning the feed unit with the first conveying unit.

FIG. 12A is a side view of an embodiment showing how a plurality of conveying units can be connected together with the unit supported by wheel-mounted pivot units; FIG. 12B is a prospective view of an embodiment showing how a plurality of conveying units can be connected together with the unit supported by wheel-mounted pivot units.

FIG. 13A is a side view of an embodiment showing how a plurality of conveying units can be linked together with one unit supported by a track-mounted pivot unit and another unit being supported by a wheel-mounted pivot units; FIG. 13B is a prospective view of an embodiment showing how a plurality of conveying units can be linked together with one unit supported by a track-mounted pivot unit and another unit being supported by a wheel-mounted pivot units.

### DETAILED DESCRIPTION OF THE PREFERRED EMBODIMENTS

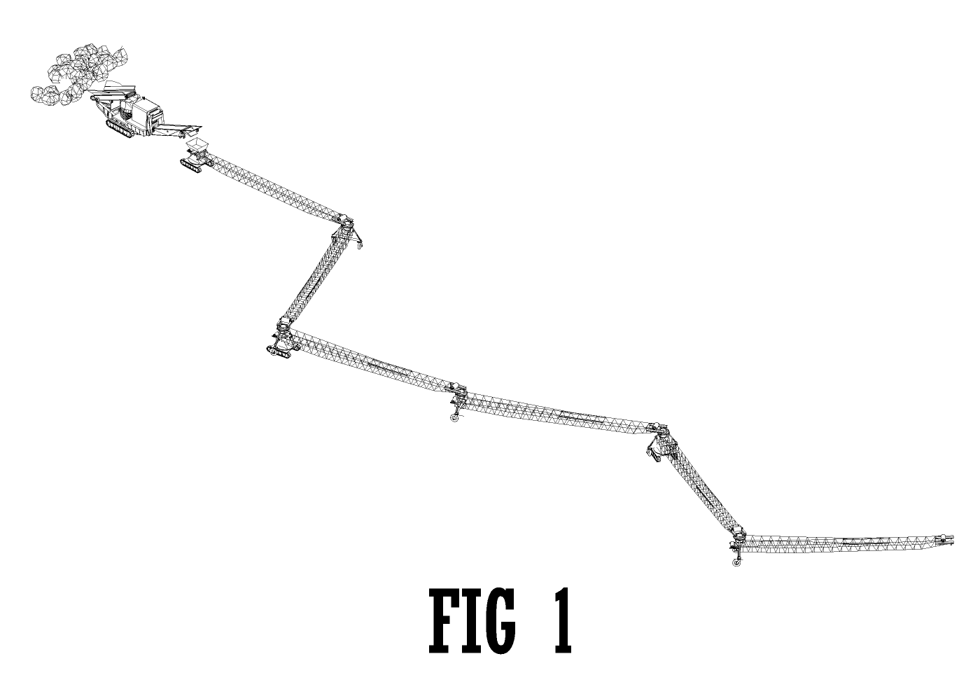

An embodiment of the Pivoting Conveyor System is shown in FIG. 1. The purpose of the Pivoting Conveyor system is to efficiently move material quarried from a rock face or other mineral source to a central processing facility. The embodiments are comprised of a feed/crusher assembly 201, a plurality of first conveying assemblies 202, and a plurality of pivot assemblies 203. In one embodiment of the Pivoting Conveyor System there is first conveying assembly 202, one pivoting assembly 203, and one outgoing feed conveyor 204 such that the out-feed of the first conveying assembly 202 is connected to the pivot assembly 203 and the out-feed from the pivoting assembly flows onto the in-feed end of the outgoing feed conveyor 204. In this preferred embodiment of the Pivoting Conveyor System 200 with two conveying assemblies, there is a feed/crusher assembly 201, an incoming or feed conveying assembly 202, a pivot assembly 203, and a second outgoing feed conveyor 204. Other embodiments include one or more outgoing feed conveyors 204.

In embodiments of the Pivoting Conveyor System 200, moving material from the mineral source to a central processing facility is done by positioning the elements of the embodiments appropriately. When minerals are being produced, the Pivoting Conveyor System is positioned to receive minerals and to convey those minerals away to the central processing facility. From time-to-time, the mineral production site must be prepared, typically by explosive means. In this situation, the Pivoting Conveyor System must be moved out of harm's way, so the elements of the Pivoting Conveyor System are used to position the feed/crusher assembly 201 away from the mineral production site.

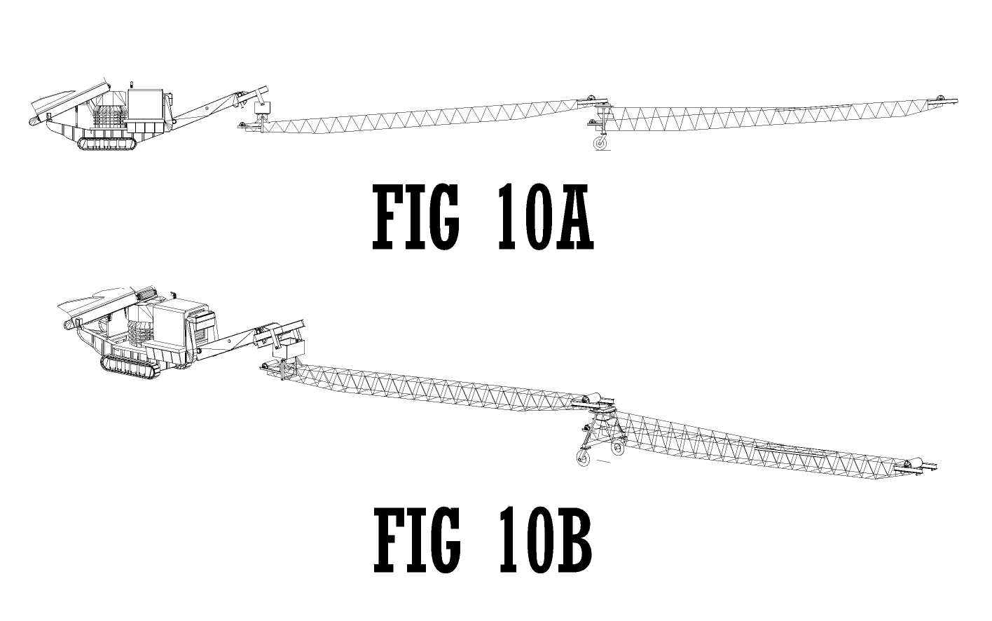

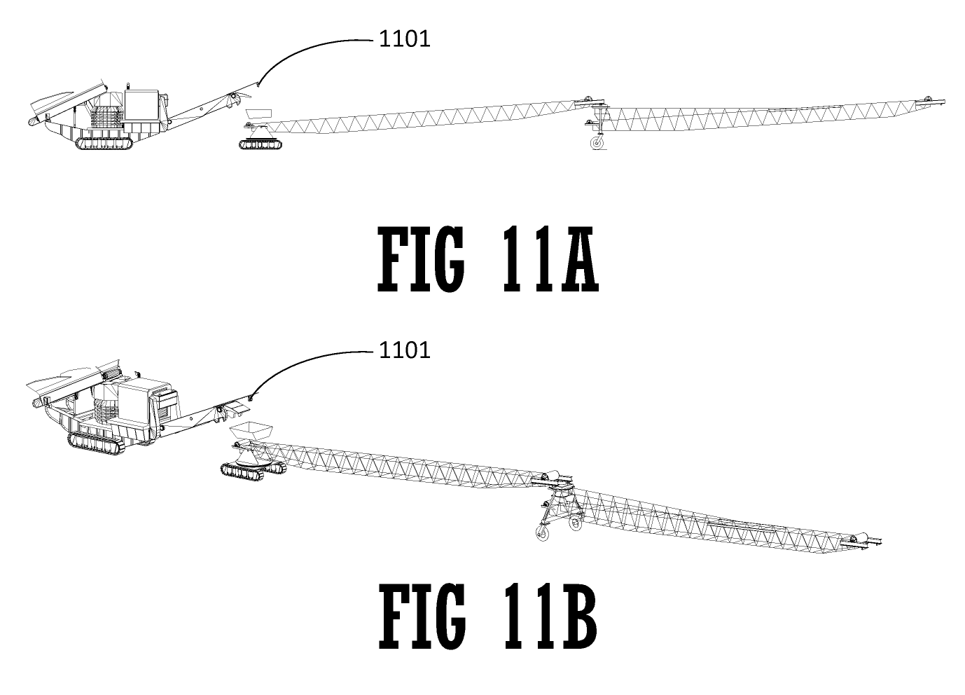

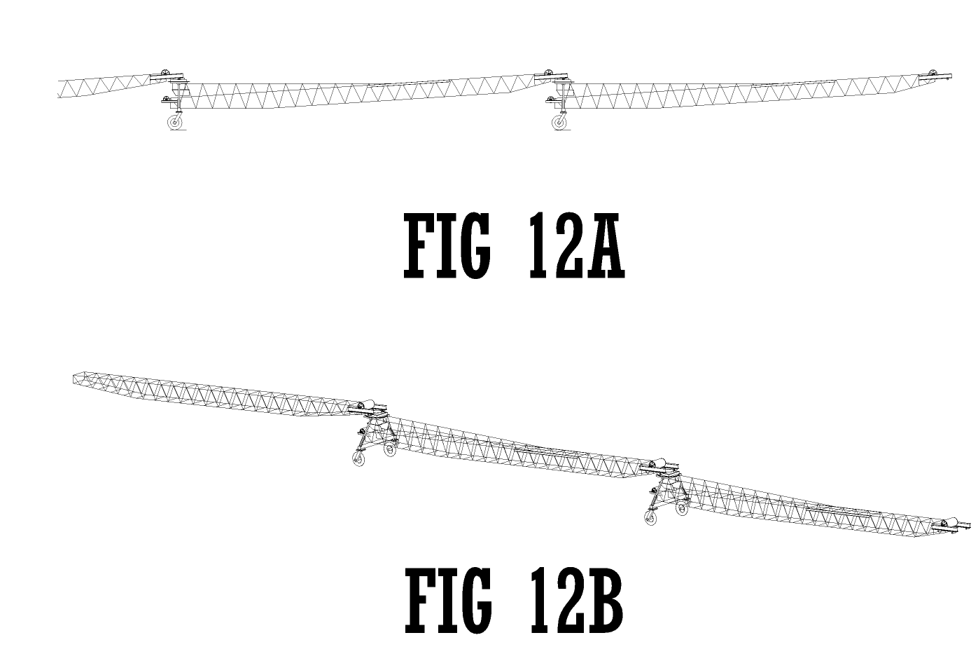

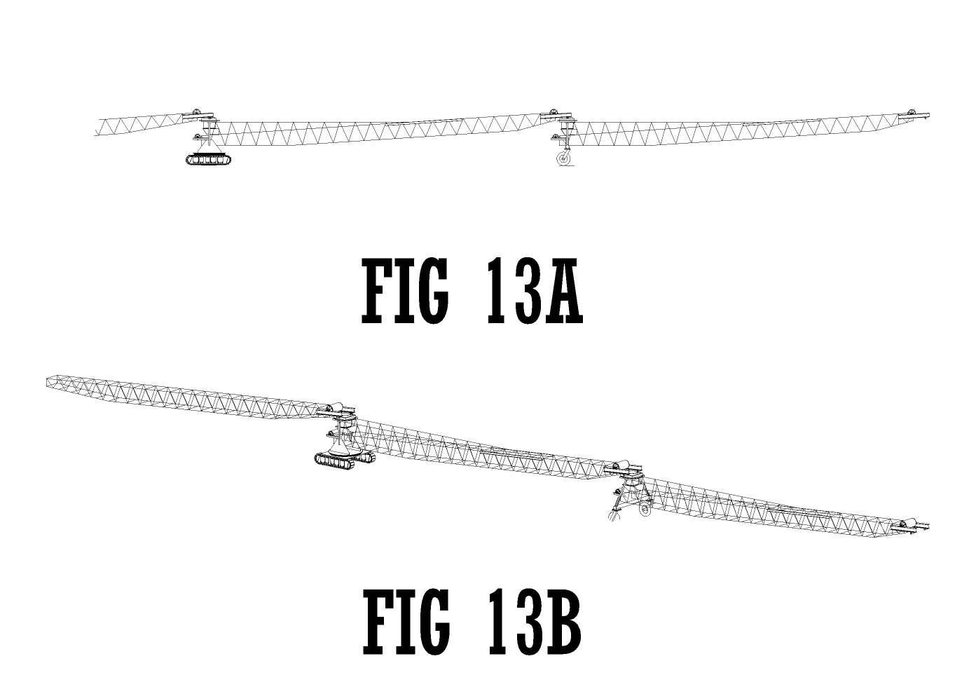

The embodiments of the Pivoting Conveyor System can be generally classified as being comprised of four types of conveying systems. The first is the system shown in FIG. 10A and FIG. 10B wherein the conveying system is connected to the crusher/feed unit. In this embodiment, the conveying system is directly connected and moves with the crusher/feed unit. A second general type of embodiment is shown in FIGS. 11A and 11B. In this embodiment, the conveying system is not physically connected to the crusher/feed unit, but is positioned via a location means on the crusher/feed unit and the end of the conveying system. In this embodiment, the conveying system serves as an intelligent slave unit to the crusher/feed unit by constantly maintaining the proper position to receive material from the crusher/feed unit. The third general type of system is shown in FIGS. 12A and 12B wherein the conveyors are mounted on wheeled pivot assemblies. These embodiments serve as slave units as the entire conveying system is moved about. FIGS. 13A and 13B are yet another alternative to this embodiment. FIGS. 13A and 13B show an embodiment using track-mounted pivot units. In this embodiment, the on track-mounted pivot units provide power and anchorage to the appropriate sections of the Pivoting Conveyor System to move the sections of the Pivoting Conveyor System as required.

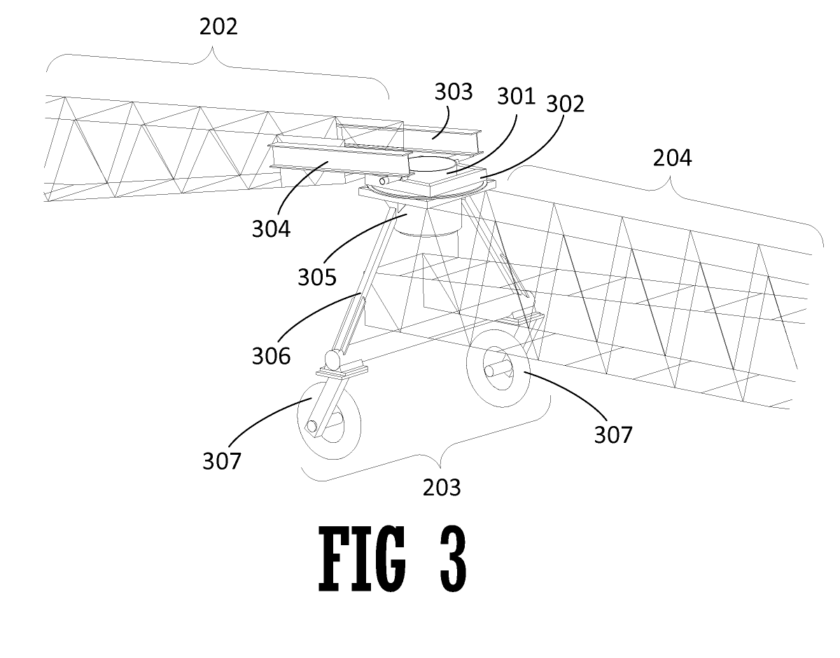

The pivoting assembly 203 is comprised of a frame supports 306 which are formed from strructual steel and is essentially a triangular shape frame. The frame is mounted on two pivot assembly wheels 307 which permit the pivot assembly to move in all directions. On top of the triangular frame supports 306 is a chute assembly which conveys the material from the incoming section to the outgoing section. All conveying sections, both incoming and outgoing, are comprised of a lattice structure of structual steel and square tubing that provides mechanical and structural support for the conveyor. The conveyor moves roughly from a low position to a higher position such that the material being conveyed is transported from the bottom of the chute to the top of the next pivoting assembly chute. The chute 301 in the pivoting assembly is comprised of a large diameter pipe framed in a rectangular tubing structure 302. In an embodiment of the invention the chute 301 is comprised of pipe. The outgoing chute is comprised of a pair of I-beams, a right chute I-beam 304 and left chute I-beam 303, which direct the conveying material into the chute 301 as shown in FIG. 3. As the conveyed material exits the outgoing chute the conveyed material drops into the chute 301 onto the moving conveyor of the outgoing chute.

The conveying assemblies 202 and the outgoing feed conveyor 204 are also comprised of conveyor belts and conveyor pulleys 503. The conveying belts and pulleys 503 are integral to the operation of all embodiments of the Pivoting Conveying System as the conveying belts directly move the minerals and materials from the beginning of the conveyors to the end of the conveyors. The conveying belts and pulleys 503 are omitted from some figures so as to avoid unnecessary clutter of the figures. However, it should be understood and appreciate that all conveying sections are comprised of conveyor belts and pulleys 503. In another embodiment of the Pivoting Conveyor System, augers or screw conveyors are used in the place of belt conveyors to convey the material.

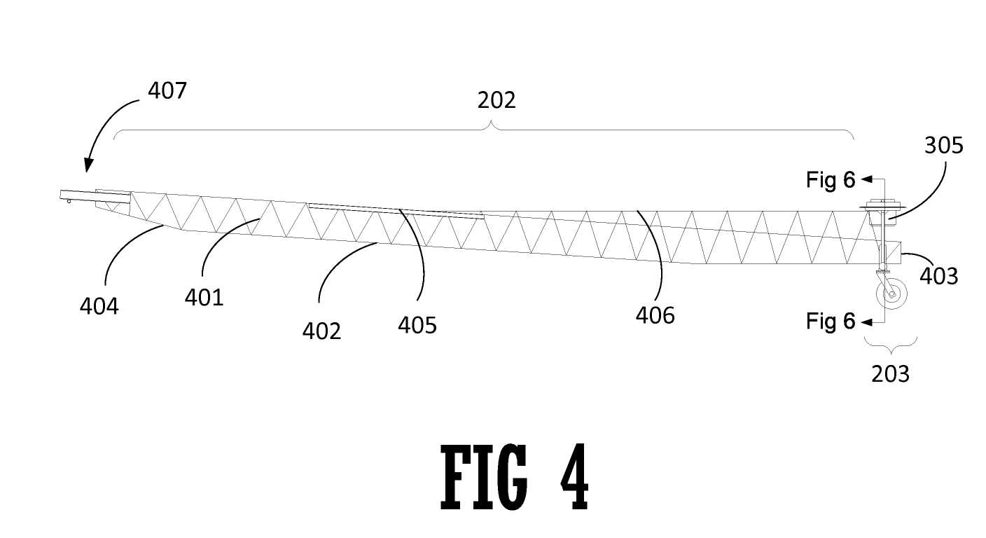

The conveying sections 202 are comprised of a lattice structure of strructual steel supports as illustrated in an embodiment in FIG. 4. These supports include without limitation a plurality of bottom feed supports 404, a plurality of diagonal supports 401, a plurality of bottom supports 402, a plurality of top supports 405, a plurality of top outgoing top supports 406, and one or more end support 403. The conveying sections 202 convey material from the infeed location 407 to the outfeed location and chute 301.

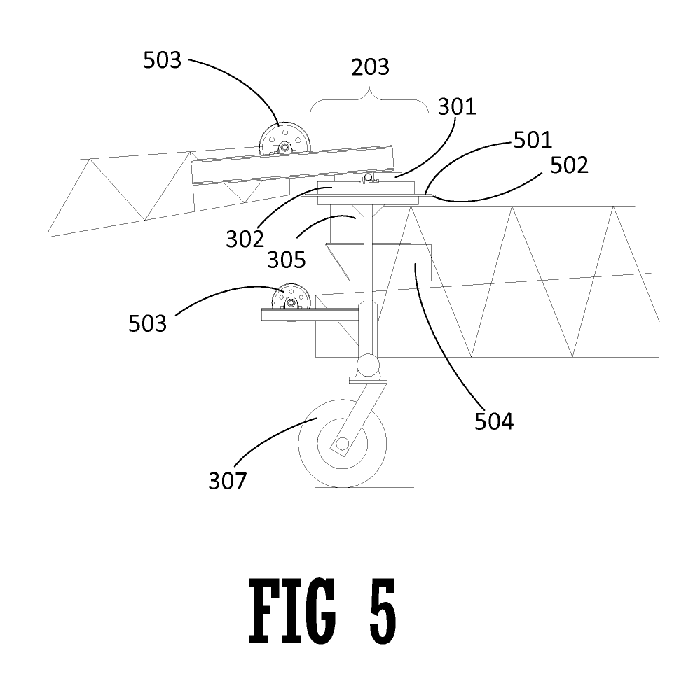

The chute assembly, as shown in FIGS. 3, 5 6, is comprised of a chute 301 and a static outer chute 305. The static outer chute 305 is welded to the lower rotating plate 502. The chute 301 is welded to the upper rotating plate 501. The lower rotating plate 502 and the upper rotating plate 501 provide the means for the Pivoting Conveyor System to rotate. The rotation around the chute 301 centerline provides for a first rotational degree of freedom. To accomplish this rotation as effortlessly as possible, grease is applied between the upper rotating plate 501 and the chute support 305. As an alternative to grease, a coating of high molecular weight polymer can be applied between the upper rotating plate 501 and the lower rotating plate 502 to reduce friction. The static outer chute 305 is welded to the lower rotating plate 502 to allow these two plates to slide over one another as the incoming and outgoing conveyors articulate. When the incoming feed conveying section rotates so as to change the angle with the outgoing conveying section, the lower rotating plate 502 and the upper rotating plate 501 rotate around the centerline of the chute 301 thereby allowing the Pivoting Conveyor System to articulate around that centerline. The lower rotating plate 502 is welded to the tubular frame structure 701 of the outgoing conveyor.

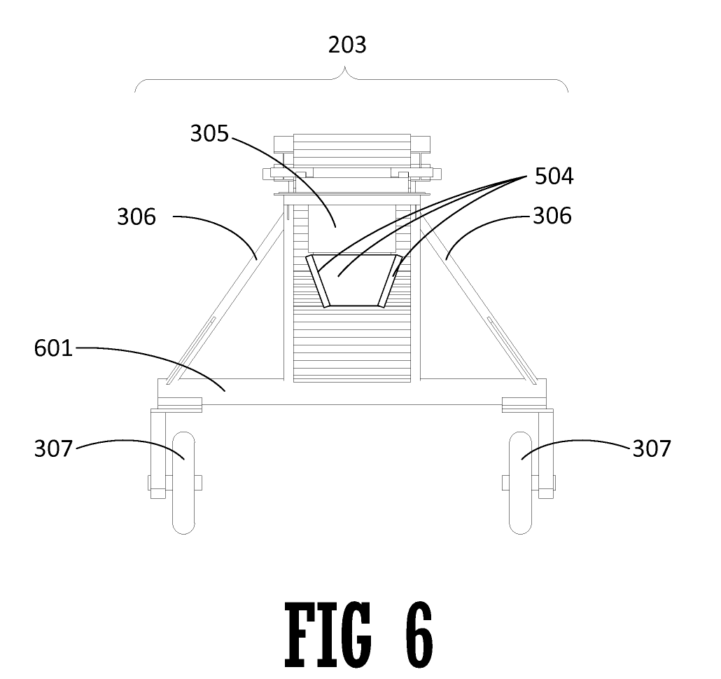

The pivoting assembly 203, as shown in FIG. 6, is comprised of frame supports 306 which is formed of strructual steel and is essentially a triangular shape frame. The frame is mounted on a pivot frame base 601 which in turn is mounted on top of two or more pivot assembly wheels 307 which permit the pivot assembly to move in all directions. On top of the triangular frames is a chute assembly which conveys the material from the incoming section to the outgoing section.

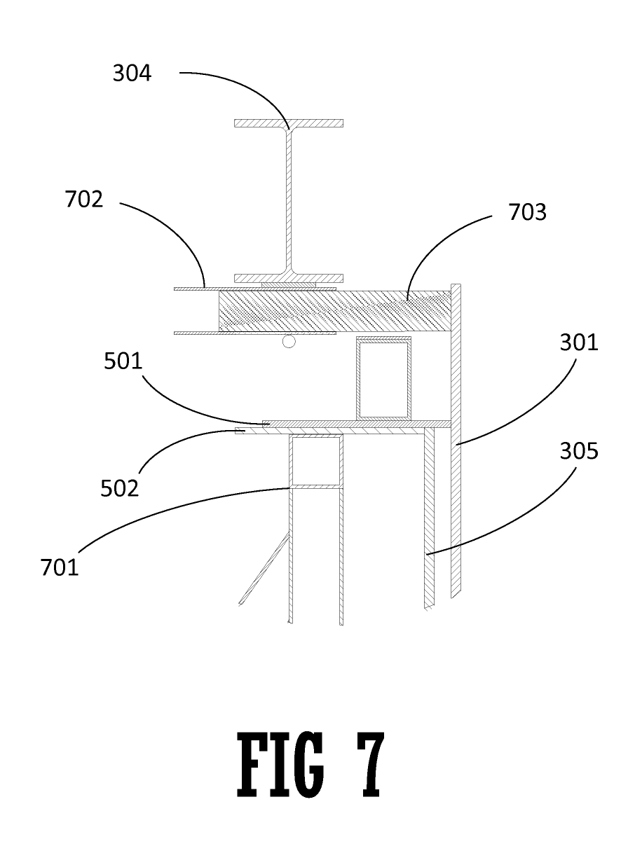

Connections between conveyor systems are made via a “pipe within a pipe” type of connection as shown in FIG. 7. The chute assembly is further comprised of an inner male pipe connector 703 which is welded to the chute 301 and to the support saddle 801. The inner male pipe connector 703 serves as a connection for the outer female pipe connector 702. The outer female pipe connector 702 is welded to right chute I-beam 304 of the incoming conveyor 202. The outer female pipe connector 702 and the inner male pipe connector 703 are free to rotate around the common centerline of the outer female pipe connector 702 and the inner male pipe connector 703. The rotation around the common centerline of the outer female pipe connector 702 and the inner male pipe connector 703 provides for a second rotational degree of freedom.

The first rotational degree of freedom of rotation around the chute 301 centerline and the second rotational degree of freedom around the common centerline of the outer female pipe connector 702 and the inner male pipe connector 703 provide the means for each incoming and outgoing conveyor pair to move relative to each other. In other words, the first and second degrees of freedom allow an incoming and outgoing conveyor pair to articulate.

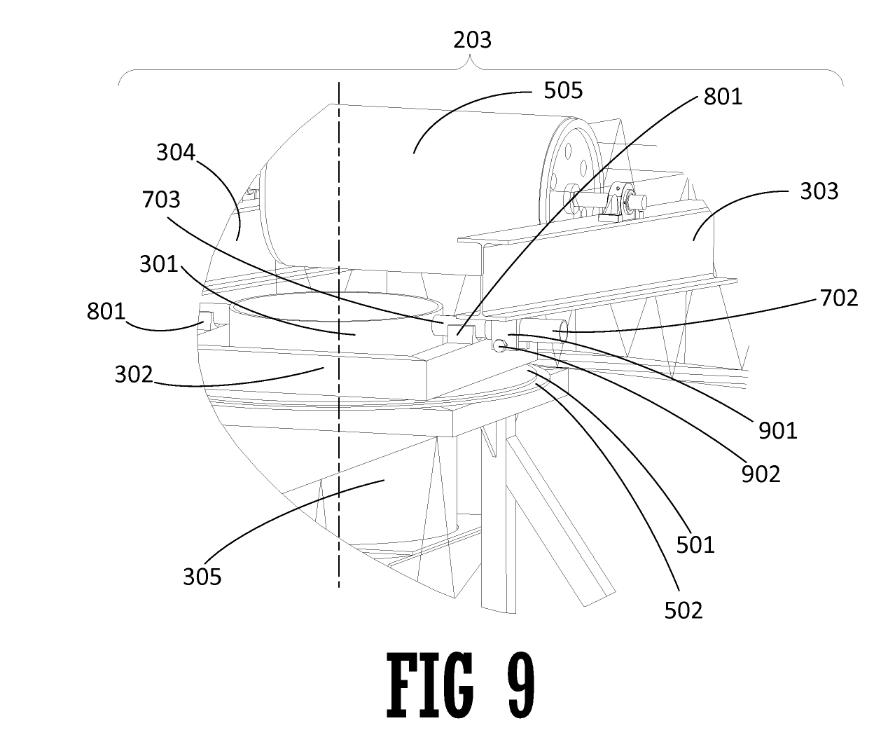

The connection between an incoming conveying section 202 and an outgoing feed conveyor 204 is made by sliding the outer female pipe connector 702 over the male pipe connector 703 as shown in FIG. 7. The connection is secured by a compression saddle 901 as shown in FIG. 9. The connection is secured by a saddle fastener 902 which constricts the compression saddle 901 around the outer female pipe connector 702 via a resistance fit thereby securing the outer female pipe connector 702 so that it cannot move longitudinally relative to the inner male pipe connector 603. However the outer female pipe connector 702 can still rotate around the inner male pipe connector 603 allowing for the required second rotational degree of freedom.

The embodiments allow for the conveyor to be loaded in the center. There is nothing on the conveyor to move the material to the center once the material has been placed on it. As the embodiments allow for the conveyor to be loaded in the center, this prevents the conveyor belt from being pulled to one side or the other and spilling material making the conveyor process more efficient. The Pivoting Conveyor System places the material in the center of the conveyor no matter at what angle or configuration the conveyors are in. This is very important to having a smooth working, efficient conveyor system. The deflector plates 504 provide the means to center the material in on the conveying units.

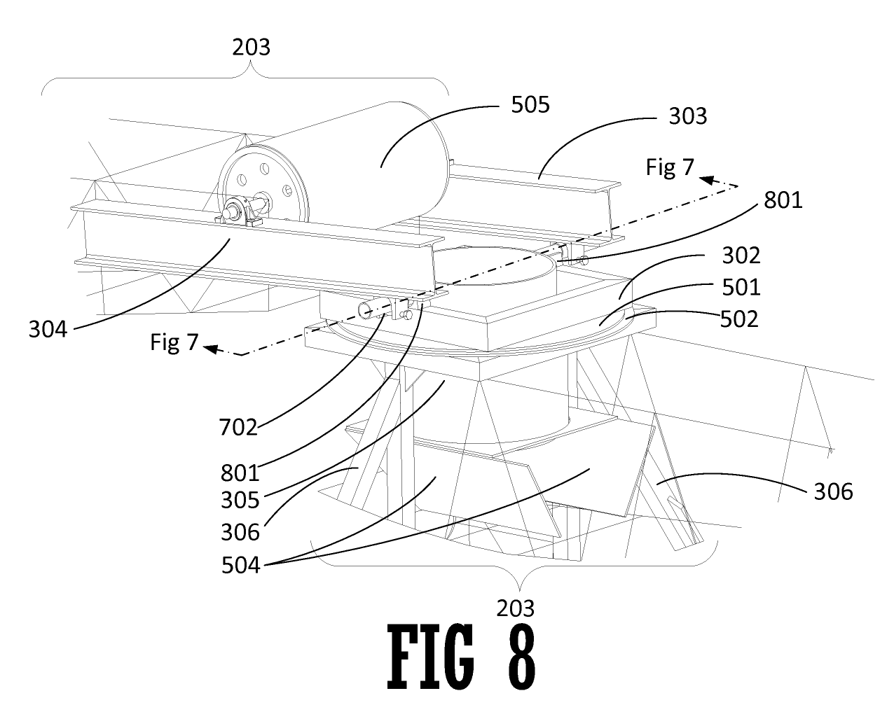

As shown in FIG. 8 as the material or minerals is transported down a conveyor section on the belt when the material reaches the end of the conveyor belt the material has velocity associated with it that will tend to force the material in the direction of the movement of the top belt. As this material goes through the chute there's a need for deflector plates 504 to eliminate this velocity in the web direction. The reason being if the material were to continue down the chute to the next conveying belt with an additional velocity this tends to increase wear and tear on the equipment particularly the conveying belt. In addition the material tends to be sporadically placed on the belt and may result in latitudinal instability of the belt. Therefore deflector plates 504 are introduced in the pivoting conveyor system so that the material as it falls through the chute is directed towards the center of the outgoing conveyor belt, down the middle of the outgoing conveyor and also reduces the velocity in the longitudinal direction to minimize wear and tear on the belt.

Embodiments of the pivoting conveyor system are also comprised of an end conveyor assembly positioning means 1101. The purpose of the end conveyor positioning means 1101 is to provide a geographical location of the end of each conveyor system. This location information is used to provide automated articulation of the pivoting conveyor system so that the pivoting conveyor system can be placed in the proper orientation for any need for conveying material from one location to another. The end conveyor positioning means includes without limitation any GPS method or means, radar, sonar, laser range finder, or any method using the electromagnetic spectrum to triangulate a given position.

If explosives are used the crusher and conveying means is commonly moved out of harm's way. Therefore, the conveying equipment needs to be moved away from the mineral face so as to enable the destruction of the mineral face by explosives. The articulation of the conveying means allows for the crusher to move away from the mineral face and then moves back close to the mineral face after the mineral face is degraded by explosives.

In another embodiment, the articulating conveyor has a number of configurations involving the feed unit, the conveying sections, and how the conveying sections are supported. In one embodiment the feed section is a crushing unit which is track-mounted. See FIG. 10A and 10B. The embodiments of the conveying sections can be either supported by track-mounted pivot units or by wheel units. As shown in FIGS. 10A and 10B, an embodiment of the Pivoting Conveyor System is comprised of conveying units where the first conveying assembly is attached to and supported by the feed unit. Remaining conveyor assemblies are supported by wheel-mounted pivot units. In another embodiment, shown in FIG. 11, the first conveying section is not attached to the crushing unit, but is automatically positioned as a slave to the end of the crushing unit that serves as a master unit. Alternatively, instead of acting as an automatic slave unit following the crushing unit, the first conveying section can be manually positioned through towing, other manual positioning means, or by controls and motors on the unit. All conveying sections can be so positioned. In another embodiment shown in FIGS. 12A and 12B, all conveying unit assemblies are supported by wheel-mounted pivot units. In yet another embodiment of the Pivoting Conveyor System shown in FIGS. 13A and 13B, the a plurality of the conveying unit assemblies are supported by track-mounted pivot units and a plurality of the conveying assembly units are supported by a wheel-mounted pivot units. As shown in FIGS. 13A and 13B, a plurality of conveying units can be connected together to form an extended conveying assembly. In FIGS. 13A and 13B, the extended conveying section has conveying units supported by both track-mounted and wheel-mounted pivot units.

In all embodiments the location of the end of each conveying section can be determined through means of a positioning system. In one embodiment the positioning system is a GPS system that can be used to relay the location of the end of the conveying section to a central computer system that can use the position of the end of the conveying sections to position the entire conveying system in the appropriate manner to deliver the material from the feed unit to the desired end location.

The operation in a typical mineral extraction operation is shown schematically in FIG. 1. In one type of such operation minerals are extracted from a mineral face typically using heavy construction equipment and explosive means. The rubble that results from this mineral face extraction is then collected and fed to a crusher. The crusher is in turn engaged to a conveying means that conveys the materials to a central processing plant. This central processing plant is typically well removed from the mineral face. If explosives are used the crusher and conveying means is commonly moved out of harm's way. Therefore, the conveying equipment need to be moved away from the mineral face so as to enable the destruction of the mineral face by explosives. The articulation of the conveying means allows for the crusher to move away from the mineral face and then moves back close to the mineral face after the mineral face is degraded by explosives.

The track-mounted pivot units provide motive force to move the entire Pivoting Conveyor System. See FIG. 1. As the application requires, the track-mounted pivot units power the Pivoting Conveyor System to a particular location and in a specific orientation. For example, when the rock face is being readied with explosives, the track-mounted pivot units move the Pivoting Conveyor System out of the way of the harmful effects of the blast and the falling debris from the blast. Once the rock face is ready, the track-mounted pivot units move the Pivoting Conveyor System into position for the purpose of conveying minerals from the vicinity of the rock face to the central processing facility. See FIG. 1. The track-mounted pivot units also serve to provide stability to the entire Pivoting Conveyor System by anchoring the configuration of the system into a specific orientation. The track-mounted pivot units are comprised of tracks, an automatic brake system as is commonly found on hydraulic crane hoists. In the automatic brake system, hydraulic fluid pressure releases a spring loaded brake, which allows causes the tracks to turn. Correspondingly, when the hydraulic pressure is released the tracks stop turning and the brakes automatically reset.

The conveying assemblies supported by a wheeled pivoting unit, See FIG. 3, are not powered. The wheeled pivot units merely provide support and as they are mechanically attached to track-mounted pivot units, are essentially pulled or pushed along when the track-mounted pivot units are activated.

In one embodiment of the Pivoting Conveyor System, the feed unit is comprised of and holds a GPS unit, and the conveying assembly nearest the feed unit is comprised of and holds a GPS unit. The position and orientation of the conveying assembly nearest the feed assembly is electronically, either by a wired or wireless means, to a central computer facility. In addition, the position and orientation of the feed unit is electronically, either by a wired or wireless means, to a central computer facility. The central computer facility, given the position and orientation of the conveying assembly nearest the feed unit and the position of the feed unit, can command the Pivoting Conveyor System to position itself to accept material from the feed unit. This master-slave processing can take place even if the conveying assembly nearest the feed unit and the feed unit are not in direct contact.

The central computer facility allows for central control of the entire Pivoting Conveyor System from a central, remote location. The central computer facility allows the operator to be able to turn the Pivoting Conveyor System on and off from an operator's console from any location. The central computer facility allows the operator to control the conveyor including commanding the Pivoting Conveyor System to automatically position itself to stay under the discharge of the belt and to remain in position to receive materials from the crusher as the crusher moves to collect more material. Further, the central computer facility allows the operator to command the Pivoting Conveyor System to retract or move away for blasting or maintenance. Further, the operator can view the central computer facility to determine that the Pivoting Conveyor System is operating properly. This surveillance includes the accurate position of each element of the Pivoting Conveyor System, pictorial representations of the orientations of the entire system, angles of approach of each element relative to adjacent elements, speed of each belt on each conveyor assembly, material rate of transport on each belt, and all other speeds, power inputs, material weights related to the transport of materials via the Pivoting Conveyor System. The central computer facility will comprise a one or more computer systems located in the central computer facility.

Determining of the position and the orientation of each element, such as each conveyor assembly, of the Pivoting Conveyor System is determined by a positioning means. The positioning means is any means of locating the end of each conveying means that receives or deposits material to or from another conveying or material processing unit. The positioning means includes any GPS method or means, radar, sonar, laser range finder, or any method using the electromagnetic spectrum to triangulate a given position.

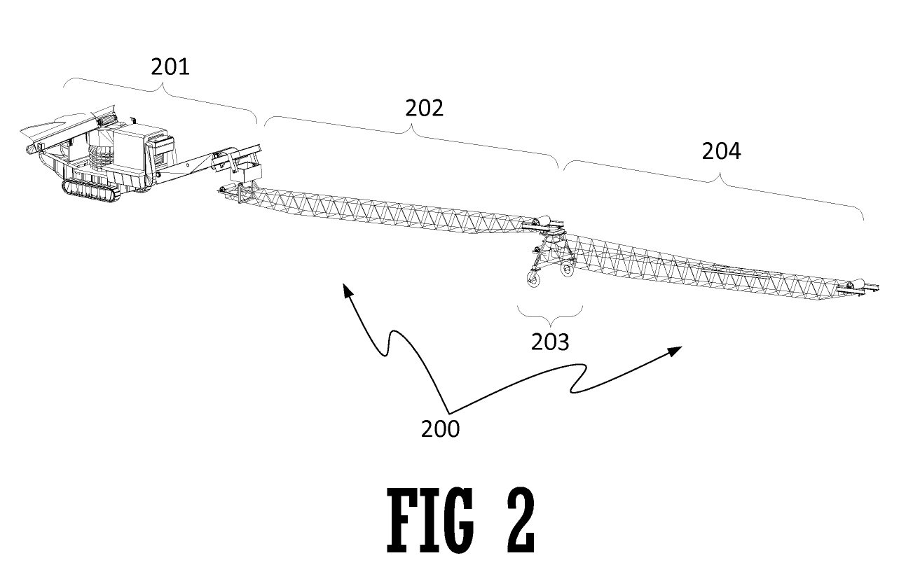

In a best mode of operation of Pivoting Conveying System, the feed/crusher assembly 201 is connected to the incoming conveyor section 202 and the outgoing feed conveyor 204. The material is guided into the chute 301 by two I-beams a left I-beam 303 and a right chute I-beam 304. The material drops through the chute 301 which is further supported by the outer chute 305 onto the conveyor belt of the outgoing feed conveyor 204 the connection between the incoming conveyor section 202 and outgoing feed conveyor 204 is accomplished by a pipe within a pipe connection system. The incoming conveyor section 202 is connected to an outer female pipe connector 702 which is slid over the inner male pipe connector 703 and in turn secured by compression saddle 901 and a saddle fastener 902 once the conveyor sections are connected the material can flow from the incoming conveyor section 202 through the pivoting assembly 203 and into the outgoing feed conveyor 204. In another best mode of operation of the Pivoting Conveyor System, the Pivoting Conveyor system is comprised of a track-mounted crushing unit as shown in FIG. 2. In this best mode, the track-mounted feed/crusher assembly 201 deposits material via a bin onto an incoming conveyor section 202, which is shown in FIG. 2 as the first section in the conveying system. This first section can either be supported by the crusher/feeder unit (See FIG. 10) or a track-mounted unit (See FIG. 11). The track-mounted feed/crusher assembly 201 moves as necessary to remain close to the material to be transported. As material is transported, the track-mounted crushing unit 201 is moved, generally in the direction of the rock face, to facilitate the mining process. The position of the hopper on the incoming conveyor section 202 is determined by the positioning means and this position is relayed to the central computer facility. The central computer facility in turn directs the incoming conveyor section 202 to automatically position itself to remain positioned to accept material discharged by the track-mounted crushing unit 201. In other words, the central computer facility directs the Pivoting Conveyor System to automatically position itself so that mining operations continue in a smooth fashion without loss of material.

The best mode of operation of the Pivoting Conveyor System allows for a readily movable conveyor system. The Pivoting Conveyor System permits the operator to easily position the conveyor system either manually or remotely, and has an anchoring system in place to hold the conveying system in the designated location. Also, with the use of a positioning means the conveyor system can follow the crusher unit automatically or by remote control. Further, the deflector plate allows for the load material to be centered on to the conveyor belt reducing material loss and increasing conveyor efficiency. Lastly, the Pivoting Conveyor System allows for the conveyor system to cover uneven ground much like a pivoting irrigation system with the added advantage of not requiring permanent anchors except the connection of the final segment to the discharge end of the conveying system. The embodiments shown in FIG. 10 and FIG. 11 allow the Pivoting Conveyor System to be used in conjunction with existing material handling systems including without limitation portable crusher units without modifications. The Pivoting Conveyor System can be employed to handle, process, and convey any bulk granular material including without limitation rock, minerals, grain, corn, coal, and sugar.

What I claim is:

1. A pivoting conveyor system comprising a
a. feed/crusher assembly,
b. a plurality of conveying assemblies,
c. a plurality of pivot assemblies.

2. The pivoting conveyor system described in claim 1 comprising
a. one first conveying assembly,
b. one pivoting assembly, and
c. one outgoing feed conveyor such that the out-feed of the first conveying assembly is connected to the pivot assembly and the out-feed from the pivoting assembly flows onto the in-feed end of the outgoing feed conveyor.

3. The pivoting conveyor system described in claim 1 comprising
a. the first conveying assemblies are connected to the crusher/feed unit where the conveying system is directly connected and moves with the crusher/feed unit; or
b. the first conveying assemblies are not physically connected to the crusher/feed unit, but the first conveying assemblies positioned via a location means on the crusher/feed unit and the feed end of the conveying system.

4. The pivoting conveyor system described in claim 3 comprising
a. the first conveying assemblies are mounted on wheeled pivot assemblies; or
b. the first conveying assemblies are mounted on track-mounted pivot units where the track-mounted pivot units provide power to move the pivot units and anchorage to the appropriate sections of the Pivoting Conveyor System to move the sections of the Pivoting Conveyor System as required.

5. The pivoting conveyor system described in claim 1 where
a. the pivoting assembly is comprised of a frame supports which are formed from structural steel and is essentially a triangular shaped frame;
b. where the frame is mounted on two pivot assembly wheels that permit the pivot assembly to move in all directions;
c. where on top of the triangular frame support is a chute assembly which conveys the material from an incoming section to an outgoing section and subsequently discharge to the incoming feed section of the next conveyor section;
d. where all conveying sections, both incoming and outgoing, are comprised of a lattice structure of strructual steel and square tubing that provides mechanical and structural support for the conveyor
e. where the conveyor moves from a low position to a higher position such that the material being conveyed is transported from the bottom of the chute to the top of the next pivoting assembly chute
f. where the chute in the pivoting assembly is comprised of a large diameter pipe framed in a rectangular tubing structure;
g. where the outgoing chute is comprised of
i. a pair of discharge chute supports,
ii. a right chute discharge chute support and left chute discharge chute support that direct the conveying material into the chute where as the conveyed material exits the outgoing end of the conveyer the conveyed material drops through the chute onto the moving conveyor of the incoming end of the following conveyor outgoing chute.

6. The pivoting conveyor system described in claim 5 where the chute assembly is comprised of a chute and a static outer chute where
a. the static outer chute is welded to a lower rotating plate;
b. the chute is welded to a upper rotating plate;
c. the lower rotating plate and the upper rotating plate provide the means for the pivoting conveyor system to rotate where the rotation around the chute centerline provides for a first rotational degree of freedom;
d. the static outer chute is welded to the lower rotating plate to allow these two plates to slide over one another as the incoming and outgoing conveyors articulate;
e. the incoming feed conveying section rotates so as to change the angle with the outgoing conveying section,
f. the lower rotating plate and the upper rotating plate rotate around the centerline of the chute thereby allowing the Pivoting Conveyor System to articulate around that centerline; and
g. the lower rotating plate is welded to the tubular frame structure of the outgoing conveyor.

7. The pivoting conveyor system described in claim 1 where conveying assemblies and the outgoing feed conveyor are comprised of conveyor belts and conveyor pulleys where the conveying belts and pulleys move the minerals and materials from the beginning of the conveyors to the end of the conveyors.

8. The pivoting conveyor system described in claim 1 where the conveying sections are comprised of a lattice structure of strructual steel supports where these supports comprise
a. a plurality of bottom feed supports;
b. a plurality of diagonal supports;
c. a plurality of bottom supports;
d. a plurality of top supports;
e. a plurality of top outgoing top supports; and
f. one or more end support;
g. where the conveying assemblies convey material from the infeed location to the outfeed location and chute.

9. The pivoting conveyor system described in claim 1 wherein each pivot assembly is comprised of
a. frame supports which are formed of structural steel and is essentially a triangular shape frame where the frame is mounted on a pivot frame base which in turn is mounted on top of two or more pivot assembly wheels which permit the pivot assembly to move in all directions;
b. mounted on top of the triangular frames is a chute assembly which conveys the material from the incoming section to the outgoing section;
c. an inner male pipe connector that is welded to the chute and to the support saddle where
i. the inner male pipe connector serves as a connection for the outer female pipe connector;
ii. the outer female pipe connector is welded to right chute I-beam of the incoming conveyor;
iii. the outer female pipe connector and the inner male pipe connector are free to rotate around the common centerline of the outer female pipe connector and the inner male pipe connector; and
iv. the rotation around the common centerline of the outer female pipe connector and the inner male pipe connector provides for a second rotational degree of freedom.

10. The pivoting conveyor system described in claim 1 wherein the connection between an incoming conveying section and an outgoing conveyor section is comprised of
a. a connection made by sliding an outer female pipe connector over a male pipe connector where the connection is secured by a compression saddle;
b. the connection is secured by a saddle fastener that constricts the compression saddle around the outer female pipe connector via a resistance fit thereby securing the outer female pipe connector so that it cannot move longitudinally relative to the inner male pipe connector;
c. the outer female pipe connector can still rotate around the inner male pipe connector allowing for a second rotational degree of freedom.

11. The pivoting conveyor system described in claim 1 wherein an incoming end of the conveyor is connected to the feed/crusher assembly and an outgoing end of the conveyor is connected to the following conveyor wherein the conveying system is directly connected to and moves with the feed/crusher assembly.

12. The pivoting conveyor system described in claim 1 comprising
a. an incoming end of the conveyor
b. an outgoing end of the conveyor
c. wherein the incoming end of the conveyor is not physically connected to the feed/crusher assembly, but is positioned via a location means on the feed/crusher assembly and the end of the conveying system; and
d. wherein the conveying system serves as an intelligent slave unit to the feed/crusher assembly by constantly maintaining the proper position to receive material from the crusher/feed unit, and
e. the outgoing end of the conveyor is connected to the conveyor following.

13. The pivoting conveyor system described in claim 1
a. wherein the conveyors are mounted on wheeled pivot assemblies; and
b. wherein the wheeled pivot assemblies serve as slave units as the entire conveying system is moved about.

14. The pivoting conveyor system described in claim 1 wherein track-mounted pivot units provide power and anchorage to the appropriate sections of the pivoting conveyor system to move the sections of the pivoting conveyor system as required.

15. A pivoting conveyor system as described in claim 14 comprising any number and combination of
a. wheel-mounted pivot units, and
b. track-mounted pivot units, wherein the number and combination of wheel-mounted pivot units and track-mounted pivot units is selected to accommodate the specific application for the pivoting conveyor system including the terrain on which the pivoting conveyor system will be used.

16. A pivoting conveyor system comprising
a. a first conveyor system portion comprised of one of the following:
i. a first conveying section attached to the crusher feed unit,
ii. a first conveying section that is not attached to the crusher feed unit, but is positioned under the crusher unit via the position locating means and includes a hopper unit on the incoming conveyor section whose position determined by the positioning means and this position is relayed to the central computer facility to adjust the locating of the hopper unit, or
iii. a first conveying section that can be manually positioned through towing, other manual positioning means, or by controls and motors on the unit.
